(19) United States
(12) Patent Application Publication
(10) Pub. No.: US 2025/0071574 A1
(43) Pub. Date: Feb. 27, 2025

(54) SYSTEMS AND METHODS OF SELECTIVE NETWORK SLICE ADMISSION CONTROL

(71) Applicant: Verizon Patent and Licensing Inc., Basking Ridge, NJ (US)

(72) Inventors: Violeta Cakulev, Millburn, NJ (US); Lixia Yan, Basking Ridge, NJ (US); Jerry Steben, Fort Worth, TX (US); Sudhakar Reddy Patil, Flower Mound, TX (US)

(21) Appl. No.: 18/452,685

(22) Filed: Aug. 21, 2023

(51) Int. Cl. H04W 24/02

(52) U.S. Cl. CPC H04W 24/02

(57) ABSTRACT

Systems and methods provide a selective network slice admission control (NSAC) service on a per user equipment (UE) device level, and include manage select NSAC criteria related to a first limit to a number of user equipment (UE) devices and a second limit to a number of protocol data unit (PDU) sessions supportable on a network slice; receive an indication that a first UE device requests a first PDU session on the network slice; apply at least one of the select NSAC criteria to the first UE device and/or the first PDU session; determine, based on the application, that the first UE device is countable toward the first limit and/or the first PDU session is countable toward the second limit; and generate an NSAC update response message indicating that the first UE device and/or the first PDU session is countable.

### BACKGROUND

Next Generation mobile networks, such as Fifth Generation (5G) mobile networks, as the next stage network in the evolution of mobile wireless networks. 5G mobile networks are designed to increase data transfer rates, enhance spectral efficiency, improve coverage, expand capacity, and reduce latency. For example, a 5G mobile network may incorporate network slicing technology to optimize network efficiency and performance. As another example, a 5G mobile network may provide mobile devices with the ability to use user equipment (UE) route selection policy (URSP) rules, to enable the mobile devices to access select services.

### BRIEF DESCRIPTION OF THE DRAWINGS

FIG. 1 illustrates concepts described herein;

FIG. 2 is a diagram illustrating a network environment in which systems and methods described herein may be implemented;

FIG. 3 is a diagram of example logical components of a core network, according to an implementation;

FIG. 4 is a table illustrating fields of a network monitoring and admission control for UE device slice usage policy, according to an implementation;

FIGS. 5 and 6 are diagrams illustrating communications, in a portion of a network environment, to perform network monitoring and admission control for UE device slice usage;

FIG. 7 is a flow diagram illustrating exemplary processes for providing a selective network slice admission control (NSAC) service, according to implementations described herein; and

FIG. 8 illustrates example components of a device according to an implementation.

### DETAILED DESCRIPTION OF EXAMPLE EMBODIMENTS

The following detailed description refers to the accompanying drawings. The same reference numbers in different drawings may identify the same or similar elements. Also, the following detailed description does not limit the invention.

Network slicing is based on the concept of creating multiple virtual networks on a common physical infrastructure. The virtual networks can be configured to provide guaranteed service levels for specific functionality requested from different applications. Currently, a 5G network can support up to 255 different slice types (e.g., based on the current 8-bit slice service type (SST) field length) and many more slices. A UE device can access no more than eight slices simultaneously. More particularly, at most eight Single-Network Slice Selection Assistance Information (S-NSSAI) can be in the Allowed and Requested NSSAI portions in signaling messages exchanged between the UE device and the 5G network.

A standards-based network slice admission control function (NSACF) may apply admission control policies or rules with respect to the number of registered UE devices allowed per network slice and/or the number of protocol data unit (PDU) sessions allowed per network slice for network slices subject to admission control. The NSACF may be configured with the maximum supportable number of registered UEs and/or the maximum supportable number of established PDU sessions per S-NSSAI ID. Currently, the number of UEs and/or PDU sessions are substantially indiscriminately counted toward the NSSAI's limit. The only criteria available—for purposes of exempting particular UEs or PDU sessions from the NSSAI's limits—are preferred access type (e.g., 3GPP, non-3GPP, or another access type), and/or whether a PDU session is dedicated for public safety, emergency preparedness, and/or other critical and priority services. Accordingly, the current NSAC framework supports little to no flexibility for a network operator deploying and configuring an NSAC in a network.

In view of the foregoing, a need exists to support application of select criteria in determining whether to count a particular UE and/or PDU session toward the applicable limit for the network slice. Systems and methods described herein relate to the support of select application of various criteria in determining whether to count a particular UE and/or PDU session. In this way, criteria such as a radio access technology (RAT)/frequency selection priority (RFSP) index, a data network name (DNN), a session and service continuity (SSC) mode, a PDU session type (e.g., an always-on PDU session, PDU type unstructured, or the like), and/or other information, such as UE location information may be used criteria in determining which particular UEs and/or PDU sessions count toward the applicable limit for the network slice, and which do not.

Some implementations of the selective NSAC service described herein may be performed by the NSACF and/or one or multiple network functions such as an access mobility and management function (AMF) and/or a session management function (SMF). In some implementations, the selective NSAC service may define network slice status reporting such that a consumer network function (e.g., application function (AF) via a network exposure function (NEF) related to the current number of registered UEs for a network slice or the current number of PDU sessions established on a network slice.

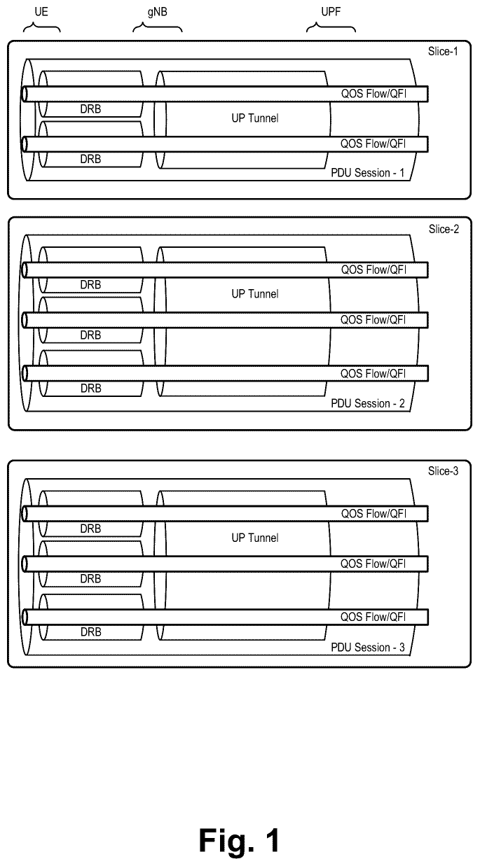

FIG. 1 illustrates concepts described herein with respect to an implementation of an exemplary selective NSAC service. A PDU session is an association between a UE device and a data network that provides a PDU connectivity service. Quality of Service (QoS) rules and policies may be mapped to user plane (UP) packets of QoS flows between a UE device and a user plane function (UPF). As shown in FIG. 1, each of the QoS flows may be associated with a QoS flow identifier (QFI). A data radio bearer (DRB) may transport one or more QoS flows between a UE device and an access station (e.g., a gNodeB) of an access network. A UP tunnel (e.g., a General Packet Radio Service Tunneling Protocol User Plane (GTP-U) tunnel) may carry a QoS flow between the access station and the UPF. A one-to-many relationship may be established between the GTP-U tunnel (using an N3 interface) and the DRBs (using an air interface).

A network slice may include one or multiple DRBs (up to the eight supported by the UE device). Thus, the UE device may support as few as one or up to eight network slices. A PDU session belongs to one and only one specific network slice instance per mobile network. Thus, different network slice instances may not share a PDU session, though different network slice instances may have slice-specific PDU sessions using the same DNN. In FIG. 1, a first network slice (Slice-1) uses two DRBs distributed among one PDU session (PDU Session-1), while a second network slice (Slice-2) and third network slice (Slice-3) each use three DRBs with one PDU session (PDU Session-2, PDU Session-3), respectively.

Currently, no mechanism exists for selective counting of particular UEs and/or PDU sessions toward an NSAC limit applicable to a particular network slice based on, for example, network resource usage or other types of criteria, as described herein. For example, application of current NSAC policies and/or rules does not support specific limitations on the number of “always-on” PDU sessions in a network slice. An always-on PDU session is a session in which user plane resources are activated for a user device during every transition from idle mode to connected mode. Always-on PDU sessions may be established for UEs requiring ultra-low latency communications. For an always-on PDU session, the user plane may be activated even when no data is being transmitted. In this way, when a user device is ready to transmit data, the user plane resources are already activated and the data can be transmitted immediately, with minimal delays and low latency. Current NSAC policies and/or rules also do not support specific limitations on the number of PDU sessions with a PDU type of unstructured, for example, in a network slice.

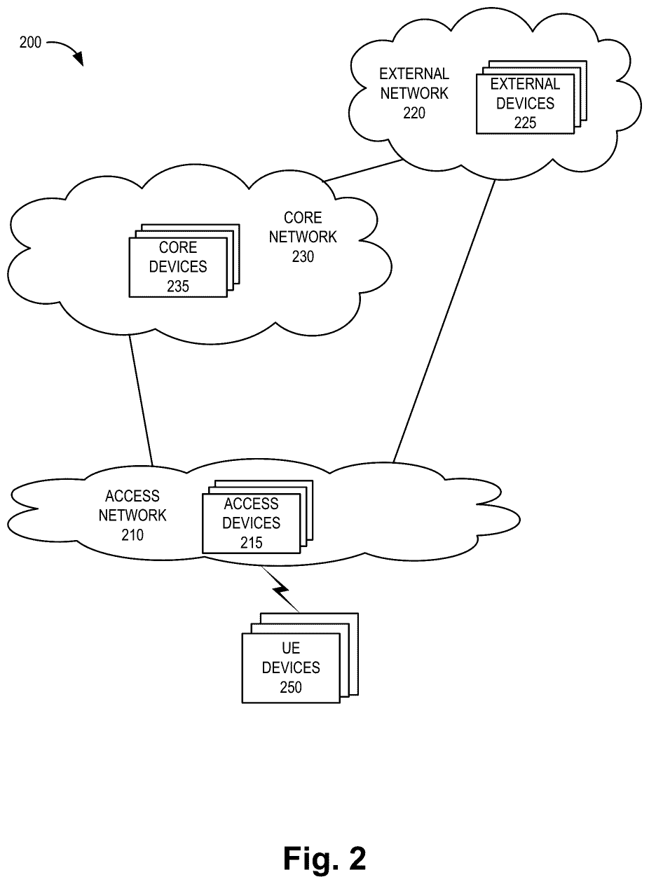

FIG. 2 is a diagram illustrating an example environment 200 in which an embodiment of the selective NSAC service may be implemented. As illustrated, environment 200 includes an access network 210, an external network 220, and a core network 230. Access network 210 includes access devices 215 (also referred to individually or generally as access device 215). External network 220 includes external devices 225 (also referred to individually or generally as external device 225). Core network 230 includes core devices 235 (also referred to individually or generally as core device 235). Environment 200 further includes UE devices 250 (also referred to individually or generally as UE device 250).

The number, type, and arrangement of networks illustrated in environment 200 are examples. In other embodiments, environment 200 may include fewer networks, additional networks, and/or different networks. For example, in other embodiments, other networks not illustrated in FIG. 2 may be included, such as an X-haul network (e.g., backhaul, mid-haul, fronthaul, etc.), a transport network (e.g., Signaling System No. 7 (SS7), etc.), or another type of network that may support a wireless service and/or an application service, as described herein.

The number, the type, and the arrangement of network devices, and the number of UE devices 250 are examples. A network device may be implemented according to one or multiple architectures, such as a client device, a server device, a peer device, a proxy device, a cloud device, and/or a virtualized network device. Additionally, the network device may be implemented according to various computing architectures, such as centralized, distributed, cloud (e.g., elastic, public, private, etc.), edge network, fog network, and/or another type of computing architecture, and may be incorporated into various types of network architectures (e.g., software defined network (SDN), virtual network, logical network, network slice, etc.).

Environment 200 includes communication links between the networks, between the network devices, and between UE devices 250 and the network/network devices. Environment 200 may be implemented to include wired, optical, and/or wireless communication links. A connection via a communication link may be direct or indirect. For example, an indirect connection may involve an intermediary device and/or an intermediary network not illustrated in FIG. 2. A direct connection may not involve an intermediary device and/or an intermediary network. The number, type, and arrangement of communication links illustrated in environment 200 are examples.

Environment 200 may include various planes of communication including, for example, a control plane, a user plane, a service plane, and/or a network management plane. Environment 200 may include other types of planes of communication. Additionally, an interface of a network device may be modified (e.g., relative to an interface defined by a standards body, such as 3GPP, 3GPP2, ITU, ETSI, GSMA, or the like) or a new interface of the network device may be provided in order to support the communication (e.g., transmission and reception of messages, information elements (IE), attribute value pairs (AVPs), objects, parameters, or other form of information) between network devices and the selective NSAC service logic of the network device, as described herein. According to various implementations, the interface of the network device may be a service-based interface, a reference point-based interface, an Open Radio Access Network (O-RAN) interface, a 5G interface, another generation of interface (e.g., 5.5G, 6G, 7G, etc.), or some other type of interface.

Access network 210 may include one or multiple networks of one or multiple types and technologies. For example, access network 210 may be implemented to include a 5G RAN, a future generation RAN (e.g., a sixth generation (6G) RAN, a seventh generation (7G) RAN, or a subsequent generation RAN). Access network 210 may also include a legacy RAN (e.g., a third generation (3G) RAN, a 4G or 4.5 RAN, etc.). Access network 210 may communicate with and/or include other types of access networks, such as, for example, a WiFi network, a Worldwide Interoperability for Microwave Access (WiMAX) network, a local area network (LAN), a Citizens Broadband Radio System (CBRS) network, a cloud RAN, an O-RAN network, a virtualized RAN (vRAN), a self-organizing network (SON), a wired network (e.g., optical, cable, etc.), or another type of network that provides access to or can be used as an on-ramp to access network 210, external network 220, and/or core network 230.

Access network 210 may include different and multiple functional splitting, such as options 1, 2, 3, 4, 5, 6, 7, or 8 that relate to combinations of access network 210 and core network 230 including an evolved packet core (EPC) network and/or an NG core (NGC) network, or the splitting of the various layers (e.g., physical layer, medium access control (MAC) layer, radio link control (RLC) layer, and packet data convergence protocol (PDCP) layer, etc.), plane splitting (e.g., user plane, control plane, etc.), a centralized unit (CU) and distributed unit (DU), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, NSA, SA, etc.), carrier aggregation (CA) (e.g., intra-band, inter-band, contiguous, non-contiguous, etc.), edge and core network slicing, coordinated multipoint (COMP), various duplex schemes (e.g., frequency division duplex (FDD), time division duplex (TDD), half-duplex FDD (H-FDD), etc.), and/or another type of connectivity service (e.g., non-standalone (NSA) new radio (NR), stand-alone (SA) NR, etc.).

According to some embodiments, access network 210 may be implemented to include various architectures of wireless service, such as, for example, macrocell, microcell, femtocell, picocell, metrocell, NR cell, Long Term Evolution (LTE) cell, non-cell, or another type of cell architecture. Additionally, according to various embodiments, access network 210 may be implemented according to various wireless technologies (e.g., radio access technologies (RATs), etc.), and various wireless standards, frequencies, bands, and segments of radio spectrum (e.g., centimeter (cm) wave, millimeter (mm) wave, below 6 gigahertz (GHz), above 6 GHz, higher than mm wave, licensed radio spectrum, unlicensed radio spectrum, higher than mm wave), and/or other attributes or technologies used for radio communication. Additionally, or alternatively, according to some embodiments, access network 210 may be implemented to include various wired and/or optical architectures for wired and/or optical access services.

Depending on the implementation, access network 210 may include one or multiple types of network devices, such as access devices 215. For example, access device 215 may include a gNB, an evolved LTE (eLTE) evolved Node B (eNB), an eNB, a radio network controller (RNC), a remote radio head (RRH), a baseband unit (BBU), an RU, a CU, a CU control plane (CU CP), a CU user plane (CU UP), a DU, a small cell node (e.g., a picocell device, a femtocell device, a microcell device, a home eNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), another type of wireless node (e.g., a WiFi device, a WiMax device, a hotspot device, etc.) that provides a wireless access service, or another type of network device that provides a transport service (e.g., routing and forwarding), such as a router, a switch, or another type of layer 3 (e.g., network layer of the Open Systems Interconnection (OSI) model) network device. Additionally, or alternatively, access device 215 may include a wired and/or optical device (e.g., modem, wired access point, optical access point, Ethernet device, etc.) that provides network access. According to some implementations, access device 215 may include a combined functionality of multiple RATs (e.g., 4G and 5G functionality, 5G and 5.5G functionality, 5G and 6G functionality, etc.) via soft and hard bonding based on demands and needs. According to some implementations, access device 215 may include an integrated functionality, such as a CU-CP and a CU-UP, or other integrations of split RAN nodes. Access device 215 may be an indoor device or an outdoor device. Access device 215 may include a controller device. For example, access device 215 may include a RAN Intelligent Controller (RIC).

According to various implementations, access device 215 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 215 may provide a wireless access service at a cell, a sector, a sub-sector, carrier, and/or other configurable level.

External network 220 may include one or multiple networks of one or multiple types and technologies. For example, external network 220 may be implemented to include a service or an application layer network, a cloud network, a private network, a public network, a multi-access edge computing (MEC) network, a fog network, the Internet, a packet data network (PDN), a service provider network, the world wide web, an Internet Protocol Multimedia Subsystem (IMS) network, a Rich Communication Service (RCS) network, an SDN, a virtual network, a data center, or other type of network that may provide access to and may host a UE device application, service, or asset (application service).

Depending on the implementation, external network 220 may include various network devices such as external devices 225. For example, external devices 225 may include servers (e.g., web, application, cloud, etc.), mass storage devices, data center devices, network function virtualization (NFV) devices, containers, virtual machines (VMs), SDN devices, cloud computing devices, platforms, and other types of network devices and/or architectures pertaining to various network-related functions (e.g., security, management, charging, billing, authentication, authorization, policy enforcement, development, etc.).

External devices 225 may host one or multiple types of application services. For example, the application services may pertain to broadband services in dense areas (e.g., pervasive video, smart office, operator cloud services, video/photo sharing, etc.), broadband access everywhere (e.g., 50/100 Mbps, ultra-low-cost network, etc.), higher user mobility (e.g., high speed train, remote computing, moving hot spots, etc.), IoTs (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), voice, conferencing, instant messaging), video streaming, and/or other types of wireless and/or wired application services.

Core network 230 may include one or multiple networks of one or multiple network types and technologies. Core network 230 may include a complementary network of access network 210. For example, core network 230 may be implemented to include an NGC network, an EPC of an LTE network, an LTE-Advanced (LTE-A) network, and/or an LTE-A Pro network, a future generation core network (e.g., a 5G, a 6G, a 7G, or beyond core network, etc.), and/or another type of core network.

Depending on the implementation, core network 230 may include various types of network devices that are illustrated in FIG. 2 as core devices 235. For example, core devices 235 may include a user plane function (UPF), a Non-3GPP Interworking Function (N3IWF), an access and management mobility function (AMF), a session management function (SMF), a unified data management (UDM) device, a unified data repository (UDR) device, an authentication server function (AUSF), a network slice selection function (NSSF), a network repository function (NRF), a policy control function (PCF), a binding support function (BSF), a network data analytics function (NWDAF), a NEF, a lifecycle management (LCM) device, an AF, a mobility management entity (MME), a packet gateway (PGW), an enhanced packet data gateway (ePDG), a serving gateway (SGW), a home agent (HA), a GPRS support node (GGSN), a home subscriber server (HSS), an authentication, authorization, and accounting (AAA) server, a policy and charging rules function (PCRF), a policy and charging enforcement function (PCEF), and/or a charging system (CS). According to other implementations, core devices 235 may include additional, different, and/or fewer network devices than those described. For example, core devices 235 may include a non-standard or a proprietary network device, and/or another type of network device that may be well-known but not particularly mentioned herein. Core devices 235 may also include a network device that provides a multi-RAT functionality (e.g., 4G and 5G, 5G and 5.5G, 5G and 6G, etc.), such as an SMF with PGW control plane functionality (e.g., SMF+PGW-C), a UPF with PGW user plane functionality (e.g., UPF+PGW-U), a service capability exposure function (SCEF) with a NEF (SCEF+NEF), and/or other combined nodes (e.g., an HSS with a UDM and/or UDR, an MME with an AMF, etc.).

According to an embodiment, at least a portion of core devices 235 may include selective NSAC service logic and an interface that supports the selective NSAC service, as described herein. According to some embodiments, other network devices of other types of networks (e.g., access network 210, external network 220, an X-haul network, or another type of network) may include selective NSAC service logic and an interface that supports the selective NSAC service, as described herein.

UE devices 250 include a device that may have computational and/or communication capabilities (e.g., wireless, wired, optical, etc.). UE device 250 may be implemented as a mobile device, a portable device, a stationary device (e.g., a non-mobile device and/or a non-portable device), a device operated by a user, or a device not operated by a user. For example, UE device 250 may be implemented as a smartphone, a mobile phone, a personal digital assistant, a tablet, a netbook, a wearable device (e.g., a watch, glasses, etc.), a computer, a gaming device, a music device, an IoT device, a drone, a smart device, or other type of wireless device (e.g., other type of UE device). UE device 250 may be configured to execute various types of software (e.g., applications, programs, etc.). The number and the types of software may vary among UE devices 250.

UE device 250 may support one or multiple RATs (e.g., 4G, 5G, and/or future generation RAT) and various portions of the radio spectrum (e.g., multiple frequency bands, multiple carrier frequencies, licensed, unlicensed, mm wave, above mm wave, etc.), various levels and genres of network slicing, DC service, and/or other types of connectivity services. Additionally, UE device 250 may include one or multiple communication interfaces that provide one or multiple (e.g., simultaneous, interleaved, etc.) connections via the same or different RATs, frequency bands, carriers, network slices, and/or other communication medium (e.g., wired, etc.). The multimode capabilities of UE device 250 may vary among UE devices 250.

For certain applications, UE device 250 may store UE Route Selection Policies (URSP). The URSP framework for a 5G System provides traffic steering rules for UE devices and enables a UE device to determine how a certain application should be handled in the context of traffic routing to an appropriate network slice. According to implementations described herein, URSP may include a preemption policy for network slices to enable device-side monitoring and prioritization for network slices. URSP may be stored, for example, in a subscriber identity module (SIM) or modem of UE device 250.

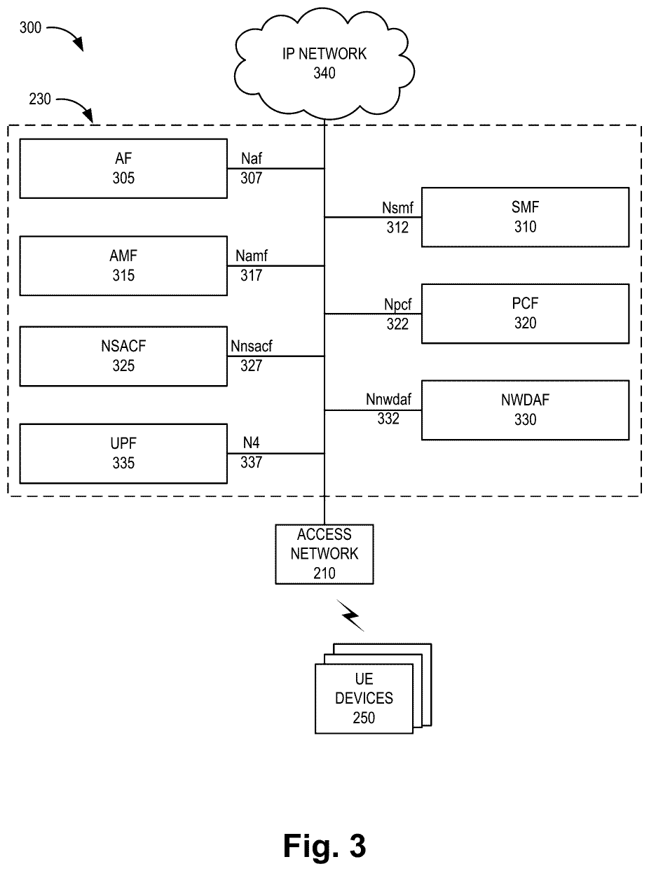

FIG. 3 is a diagram illustrating a network environment 300 that includes exemplary components of environment 200 according to an implementation of the selective NSAC service described herein. As shown in FIG. 3, network environment 300 may include UE devices 250, access network 210, core network 230, and an IP network 340. Core network 230 and IP network 340 may correspond to, or be included in, external network 220. As illustrated, environment 300 may include an AF 305, an AMF 315, an SMF 310, a PCF 320, an NSACF 325, an NWDAF 330, and a UPF 335. AF 305, AMF 315, SMF 310, PCF 320, NSACF 325, NWDAF 330, and UPF 335 may be included in core network 235. Although one AF 305, SMF 310, AMF 315, PCF 320, NSACF 325, NWDAF 330, and UPF 335 are shown in FIG. 3, multiple instances of any of this functionality may include one or more components related to a single UE device 250. For example, a single UE device 250 may access more than one network slice. Each UE device 250 may be served by a single AMF 315, but each slice may have its own SMF 310 and/or UPF 335.

Additionally, AF 305 may communicate via an Naf interface 307, SMF 310 via an Nsmf 312 interface, AMF 315 via an Namf 317 interface, PCF 320 via an Npcf 322 interface, NSACF 325 via an Nnsacf 327 interface, NWDAF 330 via an Nnwdaf 332 interface, and UPF 335 via an N4 337 interface, for example. While Naf, Nsmf, Namf, Npcf, Nnsacf, Nnwdaf, and N4 interfaces may align with nomenclature of a 3GPP service-based architecture in a control plane of a 5G core network, for example, selective NSAC service, as described herein, is not limited to such nomenclature and/or functionality. Additionally, according to some exemplary embodiments, Namf 307, Nsmf 312, Naf 317, Npcf 322, Nnsacf 327 and/or Nnwdaf 332 interfaces may operate according to some or all of the configurations and/or functionality defined by a standard (e.g., a 3GPP standard for an Namf interface, a 3GPP standard for an Nsmf interface, a standard for an Naf interface associated with a standardizing body other than 3GGP, and so forth), Namf 307, Nsmf 312, Naf 317, Npcf 322, Nnsacf 327 and/or Nnwdaf 332 may additionally operate according to an exemplary embodiment of the selective NSAC service, which has not been defined by any standard, for example. Furthermore, the interfaces of AF 305, SMF 310, AMF 315, PCF 320, NSACF 325, NWDAF 330, and UPF 335 according to various implementations, are not limited to service-based interfaces, as mentioned above. For example, SMF 310 and UPF 335 may be implemented to include N4 interface 337 that supports an embodiment of the selective NSAC service.

AF 305 may provide services associated with a particular application, such as, for example, gaming applications, applications influencing on traffic routing, interacting with a policy framework for policy control, and/or other types of applications. SMF 310 may perform session establishment, modification and/or release; perform IP address allocation and management; perform Dynamic Host Configuration Protocol (DHCP) functions; perform selection and control of UPF 335; configure traffic steering at UPF 335 to guide traffic to the correct destination; terminate interfaces toward PCF 320; perform lawful intercepts; charge data collection; support charging interfaces; control and coordinate charging data collection; terminate session management parts of Non-Access Stratum (NAS) messages; perform downlink data notification; manage roaming functionality; and/or perform other types of control plane processes for managing user plane data. SMF 310 may further include logic that provides the selective NSAC service, as described herein.

AMF 315 may perform registration management, connection management, reachability management, mobility management, lawful intercepts, Short Message Service (SMS) transport between UE device 250 and an SMS function, session management message transport between UE device 250 and SMF 310, access authentication and authorization, location services management, support of non-3GPP access networks, and/or other types of management processes. AMF 315 may page UE device 250 based on mobility category information associated with UE device 250 obtained from a Unified Data Management (UDM) function. AMF 315 may further include logic that provides the selective NSAC service, as described herein, PCF 320 may support policies to control network behavior, provide policy rules to control plane functions (e.g., to SMF 310), access subscription information relevant to policy decisions, perform policy decisions, and/or perform other types of processes associated with policy enforcement.

NSACF 325 may apply admission control policies with respect to network slices to limit the number of user devices registered per slice and/or the number of active PDU sessions per S-NSSAI subject to NSAC. According to an implementation described herein, network slice status reporting may be defined such that an NF (e.g., an AF (not illustrated)) may subscribe to NSACF 325 for network slice status notifications and/or reports. In some implementations, per the subscription, NSACF 325 may provide event-based notifications and/or reports to the user NF (e.g., via an NEF) related to the current number of UEs 250 registered for one or more S-NSSAIs and/or the current number of PDU sessions established for one or more of the S-NSSAIs. NSACF 325 may further include logic that provides the selective NSAC service, as described herein.

NWDAF 330 may collect analytics information associated with access network 210 and/or core network 230. NWDAF 330 may obtain data (e.g., statistics, metric values, events, etc.) from such devices/networks and may provide data analytics functions that may be configured by a network operator, for example. UPF 335 may maintain an anchor point for intra/inter-RAT mobility, maintain an external PDU point of interconnect to a particular external network 220, perform packet routing and forwarding, perform the user plane part of policy rule enforcement, perform packet inspection, perform lawful intercept, perform traffic usage reporting, perform QoS handling in the user plane, perform uplink traffic verification, perform transport level packet marking, perform downlink packet buffering, forward an “end marker” to a access network 210 node, and/or perform other types of user plane processes. According to implementations described herein, each of AF 305, SMF 310, AMF 315, PCF 320, NSACF 325, NWDAF 330 may support a new data type (e.g., information element (IE)) to indicate applicable criteria for determining whether a particular UE 250 and/or a particular PDU session is to be counted toward respective limits for each for a particular S-NSSAI. As described further herein, an AF may subscribe to a selective NSAC service in which NSACF 325 may receive the selective NSAC criteria IE from SMF 310 and/or AMF 315, in an NSAC request message, for example, and NSACF 325 may provide the IE, in an NSAC response message, for example, to SMF 310 and/or AMF 315 indicating whether UE device 250 and/or the PDU session is included in an updated number of UEs and/or PDU sessions for the associated S-NSSAI.

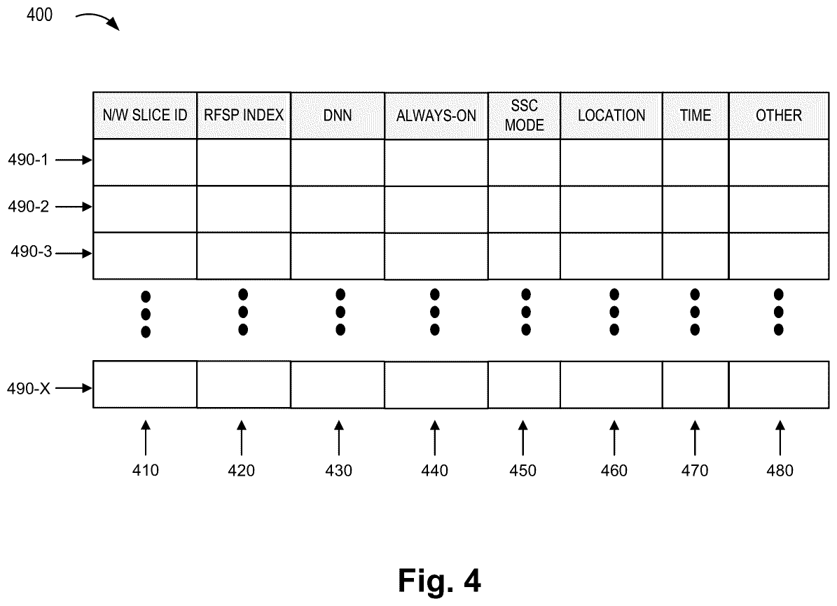

FIG. 4 is a diagram illustrating exemplary selective NSAC service criteria that may be stored, for example, by NSACF 325. As illustrated, a table 400 may include a network slice identifier field 410, an RFSP index field 420, a DNN field 430, an always-on mode field 440, an SSC mode 450, a location field 460, a time field 470, and one or multiple other fields 480. As further illustrated, table 400 includes records 490-1 through 490-X (also referred to as records 490, or individually or generally as record 490) that each includes a grouping of fields 410 through 480 (e.g., correlated information). Network slice selection service criteria is illustrated in tabular form merely for the sake of description. In this regard, selective NSAC service criteria may be implemented in a data structure different from table 400. The number and/or types of fields illustrated and described are exemplary.

Network slice identifier field 410 may store data indicating a network slice identifier, an S-NSSAI or an SST value, for example, as described herein. Network slice identifier field 410 may also store data that identifies an application or an application service associated with the identified network slice. RFSP index field 420 may include a UE-specific value that defines spectrum permissions that apply to each radio bearer of UE 250. In some embodiments, the UE-specific value may include a discrete value and/or a range of values.

DNN field 430 may store data that indicates a selected DNN that defines the point through which UEs 250 connect via access network 210. In some implementations, the DNN value may correspond to a fixed or dynamic IP address for UEs 250. Always-on field 440 may store data that indicates whether the PDU session has been established as an always-on PDU session, for example, in response to a request by a user of UEs 250 and/or without such request. SSC mode field 450 may store data that determines how the UPF of the PDU session is allocated and managed during the session lifetime.

Location field 460 may store data that indicates location information associated with UE 250. For example, the location data may be implemented to include a cell identifier, access device 215 identifier (e.g., a gNB identifier or the like), a tracking area (TA), a routing area, a registration area, and/or another type of geographic data that indicates a coverage or location area. In some embodiments, the location information may include a discrete value and/or a range of values. For example, a weighted value may correspond to a distance measurement.

Time field 470 may store data that indicates time information. For example, the time information may include a time-of-day window (e.g., 3 pm-10 pm, 7:30 am-5:30 pm, etc.). The time information may include day of the week information (e.g., Monday-Friday, etc.). The time information may include other time indicators.

Other field 480 may store data that indicates one or multiple other types of descriptors. For example, other field 480 may store data pertaining to or indicating a destination fully qualified domain name (FQDN), a PDU session type (e.g., Ethernet, unstructured, etc.), a preferred access type (e.g., 3GPP, non-3GPP, or another type of access type), a RAT (e.g., 5G, LTE, Wi-Fi, etc.), connection capability (e.g., MMS, Internet, etc.) and/or another type of known, standardized, or proprietary descriptor (e.g., traffic descriptor, route selection descriptor (RSD)). In some embodiments, the descriptors may include a discrete value and/or a range of values.

According to other exemplary implementations, table 400 may store additional, fewer, and/or different instances of selective NSAC service information in support of the selective NSAC service, as described herein. In some implementations, one or more of fields 420-480 may include a range of values.

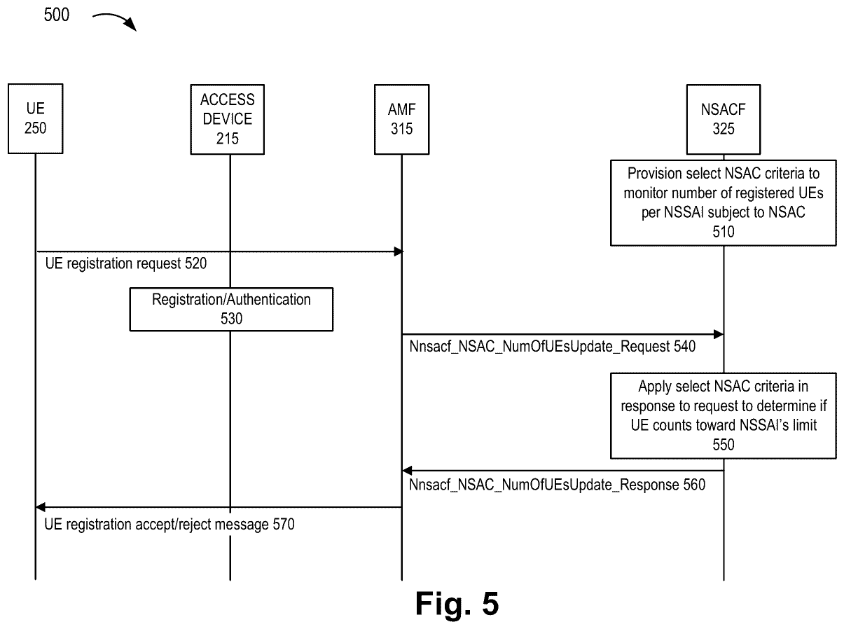

FIG. 5 is a diagram illustrating communications in a portion 500 of network environment 200 to perform network monitoring and network slice access control of UE device slice usage. As shown in FIG. 5, network portion 500 may include UE device 250 and one or multiple network function (NF) nodes that may correspond to one or more core devices 235, such as SMF 310, AMF 315, NSACF 325, and/or NWDAF 330. FIG. 5 provides simplified illustrations of communications in network portion 500 and is not intended to reflect every signal or communication exchanged between devices/functions.

Communications in FIG. 5 illustrate use of a new data type, referred to herein as a selective NSAC criteria data type, to manage NSAC policies for one or more network slices subject to NSAC. As shown in FIG. 5, NSACF 325 may, using the selective NSAC criteria defined for respective network slices, monitor and/or control the total slice utilization for registered UE devices 250 according to applicable NSAC policies 510. For example, NSACF 325 may be provisioned to apply one or more criteria from table 400 to identify which UE devices 250 registered on a network slice are to be counted toward the corresponding network slice limit. For example, NSACF 325 may not count any one UE device 250 toward the slice limit total unless one or more of the criteria are met. In some implementations, a particular combination of the criteria must be satisfied before triggering an incremental count of a particular UE device 250 requesting registration in a particular network slice. NSACF 325 may check the subscription data (e.g., for specific network slice eligibility) and local policy for UE device 250 and/or an NSSAI to determine the applicable criteria from table 400.

Referring to FIG. 5, UE device 250 may send a UE registration request 520 to AMF 315 or other core device 235, via access device 215 to initiate a registration and/or authentication procedure 530 for UE device 250. AMF 315 may generate a request 540 (e.g., Nnsacf_NSAC_NumOfUEs_Update_Request) for an update to the number of UEs for the

NSSAI identified in request 540. AMF 315 may generate request 540 even if the UE limit has been reached for the corresponding network slice, in view of the potential that UE device 250 may not be counted toward the limit according to implementations described herein. That is,

NSACF 325 may check select NSAC criteria against UE device 250 identified in request 540 in determining the current UE count for the requested network slice 550. Based on the results of the determination to count or not count UE device 250 toward the corresponding NSSAI's limit, NSACF 325 may generate a response 560 (e.g., Nnsacf_NSAC_NumOfUEsUpdate_Response) with an update to the total number of UEs. Based on response 560, AMF 315 may generate a registration accept or reject message 570 and transmit message 570 to UE device 250 regarding its use of the corresponding network slice.

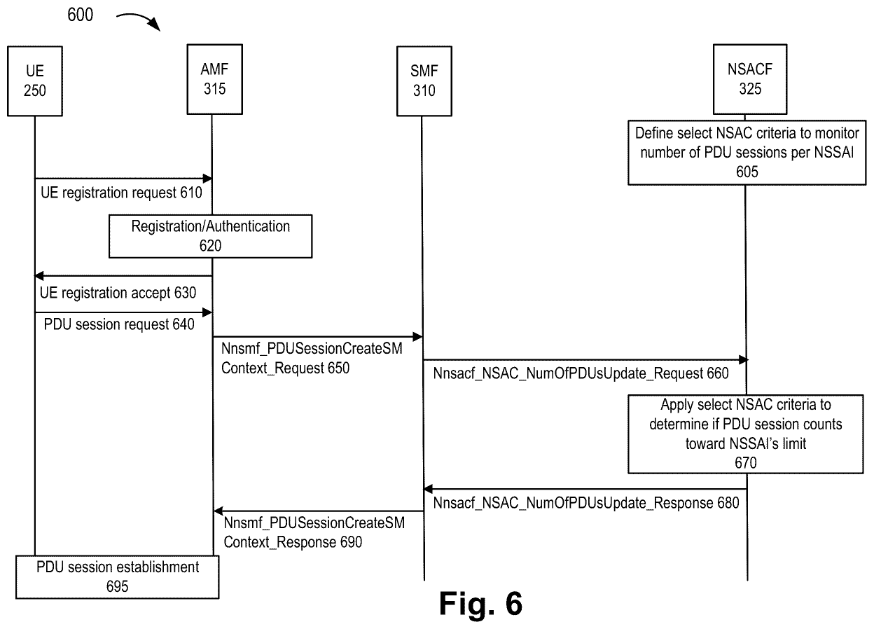

FIG. 6 is a diagram illustrating communications in a portion 600 of network environment 200 to perform network monitoring and network slice access control of UE device slice usage. As shown in FIG. 6, network portion 600 may include UE device 250 and one or multiple NF nodes that may correspond to one or more core devices 235, such as SMF 310, AMF 315, and/or NSACF 325. FIG. 6 provides simplified illustrations of communications in network portion 600 and is not intended to reflect every signal or communication exchanged between devices/functions. For simplicity, access device 215 is not shown in network portion 600, even though access device 215 may be present as shown in network portion 500, and may perform similar communications as described above with respect to FIG. 5.

Communications in FIG. 6 illustrate use of the selective NSAC criteria data type described herein to manage NSAC policies for one or more network slices subject to NSAC. As shown in FIG. 6, NSACF 325 may, using the selective NSAC criteria provisioned for respective network slices, monitor and/or control the total slice utilization for PDU sessions according to applicable NSAC policies 605. For example, NSACF 325 may be provisioned to apply one or more criteria from table 400 to identify which PDU sessions established on a network slice are to be counted toward the corresponding network slice limit. For example, NSACF 325 may not count any one PDU session toward the slice limit total unless one or more of the criteria are met. In some implementations, a particular combination of the criteria must be satisfied before triggering an incremental count of a particular PDU session in a particular network slice. NSACF 325 may check the subscription data (e.g., for specific network slice eligibility) and local policy for UE device 250 and/or an NSSAI to determine the applicable criteria from table 400.

Referring to FIG. 6, UE device 250 may send a UE registration request 610 to AMF 315 or other core device 235, via access device 215 (not shown), to initiate a registration and/or authentication procedure 620 for UE device 250. Based on the results of procedure 620, AMF 315 may generate and transmit a UE registration accept message 630 to UE 250. According to an exemplary embodiment, the selective NSAC service may include invoking a PDU session establishment procedure. Based on receipt of message 630, UE device 250 may generate and transmit a PDU session request 640 to AMF 315 (or another/new AMF). Request 640 may include cause data, a context identifier, and/or source and target network slice identifiers. In response to request 640, AMF 315 may generate and transmit a request 650 (e.g., Nsmf_PDUSessionCreateSMContext_Request) to SMF 310 for initiating the PDU session establishment procedure for the NSSAI included in request 640. AMF 315 may select an SMF based on the source and target network slice identifiers and/or other information (e.g., cause data, context identifier, etc.).

SMF 310 may generate a request 660 (e.g., Nnsacf_NSAC_NumOfPDUs_Update_Request) for an update to the number of PDU sessions for the NSSAI identified in request 660. SMF 310 may generate request 660 to NSACF 325 even if the PDU session limit has been reached for the corresponding network slice, in view of the potential that the PDU session does not qualify toward the limit according to implementations described herein.

NSACF 325 may check select NSAC criteria against the PDU session identified in request 660 in determining the current PDU session count for the requested network slice 670. Based on the results of the determination to count or not count the PDU session toward the corresponding NSSAI's limit, NSACF 325 may generate a response 680 (e.g.,

Nnsacf_NSAC_NumOfPDUsUpdate_Response) with an update to the total number of PDU sessions. Based on response 680, SMF 315 may generate and transmit a request 690 (e.g., Nsmf_PDUSessionCreateSMContext_Response) to UE device 250 for establishing the PDU session for the NSSAI. In turn, AMF 310 may complete the PDU session establishment procedure 695.

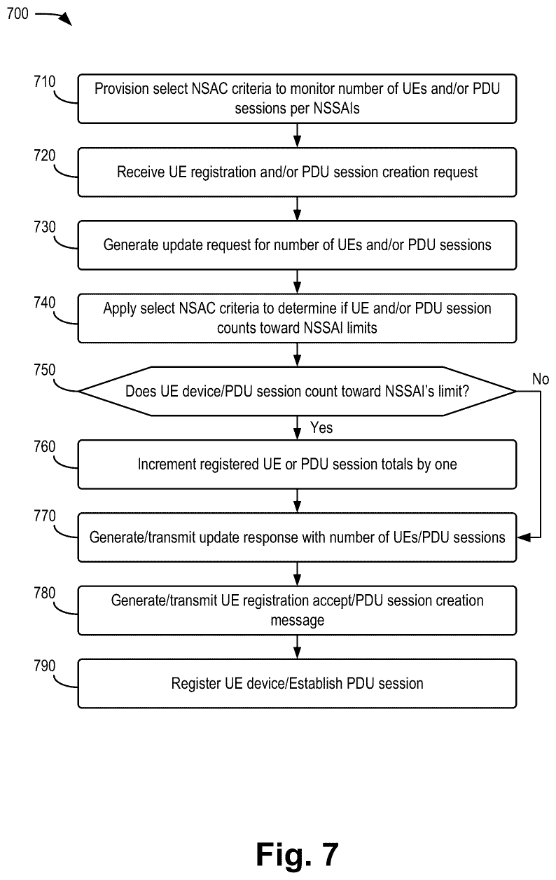

FIG. 7 is a flow diagram illustrating an exemplary process 700 for providing a selective NSAC service, according to implementations described herein. In one implementation, process 700 may be implemented by one or more core devices 235, such as NSACF 325, AMF 315, and/or SMF 310. In another implementation, process 700 may be implemented by one or more core devices 235 in conjunction with UE device 250.

Process 700 may include provisioning select NSAC criteria provisioned for each NSSAI to monitor the current number of registered UEs and/or established PDU sessions controlled with respect to each NSSAI's threshold limit(s) (block 710), and receiving a UE device registration request and/or a PDU session creation request (block 720). For example, registered UE devices currently engaged in network slice usage and which are selectively qualified for counting toward the threshold limit of the corresponding network slice are included in NSAC updates, whereas non-qualifying registered UE devices currently engaged in network slice usage may not be counted at all and/or may be counted at a discounted weight.

Process 700 may also include generating an update request for the number of UEs and/or PDU session currently using resources on the identified network slice (block 730) and, in response, applying select NSAC criteria to determine if the UE device and/or the PDU session qualifies for counting toward the respective limits defined per the associated NSSAI (block 740). For example, the criteria indexed to an NSSAI ID may be compared to the attributes of the UE device and/or the serving network slice, such as an RFSP index, the DNN, the “always-on” status, the SSC mode, the UE's location, etc. In some implementations, the application may be terminated after one criterion of the defined criteria is determined to be satisfied.

If, under the select NSAC criteria, the UE device and/or the PDU session qualify for the NSSAI's limit (block 750—Yes), process 700 may include incrementing the registered UE or PDU session totals by one (block 760). In some implementations, two, three, or some other designated number of the criteria may need to be satisfied (e.g., matched) to qualify the UE device and/or the PDU session for counting toward the NSSAI's limit.

Following the incrementing operation, or if the UE device and/or the PDU session qualify for the NSSAI's limit (block 750—No), and assuming that the limit has not been reached, process 700 may include generating and/or transmitting an update response with the number of UEs and/or PDU sessions (block 770). Process 700 may further include generating and/or transmitting a UE registration accept and/or PDU session creation message (block 780), and registering the UE device and/or establishing the new PDU session.

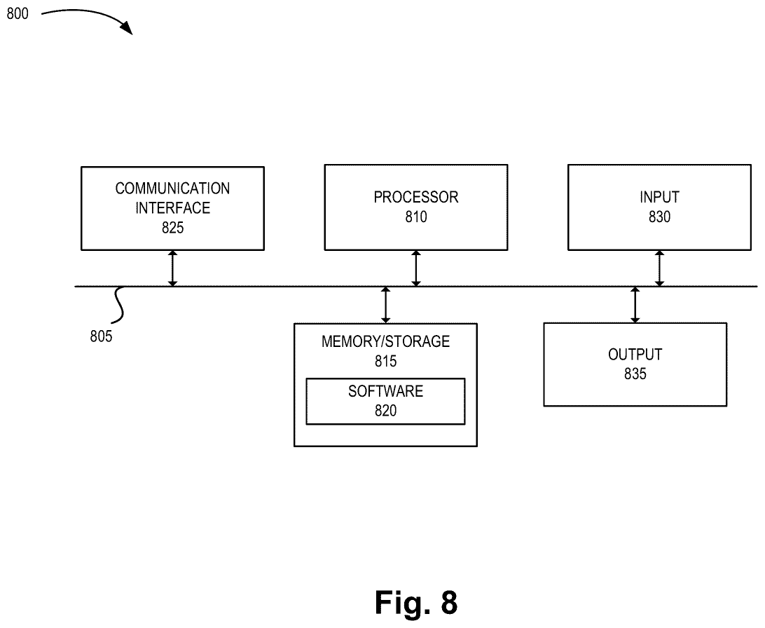

FIG. 8 illustrates example components of a device 800 according to an implementation described herein. Components of UE device 250, AF 305, SMF 310, AMF 315, PCF 320, NSACF 325, NWDAF 330, UPF 335, and other network devices in environment 200 may each include or be implemented on one or more devices 800. Device 800 may include a bus 805, a processor 810, a memory/storage 815 that stores software 820, a communication interface 825, an input 830, and an output 835. According to other embodiments, device 800 may include fewer components, additional components, different components, and/or a different arrangement of components than those illustrated in FIG. 8 and described herein.

Bus 805 includes a path that permits communication among the components of device 800. Processor 810 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 810 may be implemented as hardware (e.g., a microprocessor, etc.), a combination of hardware and software (e.g., a SoC, an ASIC, etc.), may include one or multiple memories (e.g., cache, etc.), etc.

Processor 810 may control the overall operation, or a portion of operation(s) performed by device 800. Processor 810 may perform one or multiple operations based on an operating system and/or various applications or computer programs (e.g., software 820). Processor 810 may access instructions from memory/storage 815, from other components of device 800, and/or from a source external to device 800 (e.g., a network, another device, etc.).

Memory/storage 815 includes one or multiple memories and/or one or multiple other types of storage mediums. Memory/storage 815 may store data, software, and/or instructions related to the operation of device 800. Software 820 includes an application or a program that provides a function and/or a process. Software 820 may also include firmware, middleware, microcode, hardware description language (HDL), and/or other form of instruction. Software 820 may also be virtualized. Software 820 may further include an operating system (OS) (e.g., Windows®, Linux®, Android®, proprietary, etc.).

Communication interface 825 permits device 800 to communicate with other devices, networks, systems, and/or the like. Communication interface 825 includes one or multiple wireless interfaces and/or wired interfaces. For example, communication interface 825 may include one or multiple transmitters and receivers, or transceivers. Communication interface 825 may operate according to a protocol stack and a communication standard. Communication interface 825 may include an antenna. Communication interface 825 may include various processing logic or circuitry (e.g., multiplexing/de-multiplexing, filtering, amplifying, converting, error correction, application programming interface (API), etc.). Communication interface 825 may be implemented as a point-to-point interface, a service-based interface, or a reference interface, for example. Input 830 permits an input into device 800. Output 835 permits an output from device 800.

As previously described, a network device may be implemented according to various computing architectures (e.g., in a cloud, etc.) and according to various network architectures (e.g., a virtualized function, etc.). Device 800 may be implemented in the same manner. For example, device 800 may be instantiated, created, deleted, or some other operational state during its life-cycle (e.g., refreshed, paused, suspended, rebooting, or another type of state or status), using well-known virtualization technologies (e.g., hypervisor, container engine, virtual container, virtual machine, etc.) in an application service layer network (e.g., external network 220) and/or another type of network (e.g., access network 210, core network 230, etc.). Thus, network functions described herein may be implemented as device 800.

Device 800 may perform a process and/or a function, as described herein, in response to processor 810 executing software 820 stored by memory/storage 815. By way of example, instructions may be read into memory/storage 815 from another memory/storage 815 (not shown) or read from another device (not shown) via communication interface 825. The instructions stored by memory/storage 815 may cause processor 810 to perform a function or a process described herein. Alternatively, for example, according to other implementations, device 800 performs a function or a process described herein based on the execution of hardware (processor 810, etc.).

Systems and methods described herein provide a selective NSAC service on a per UE device and/or PDU session level. In this manner, UE devices and/or PDU sessions are not indiscriminately counted toward the respective limits for a requested network slice usage subject to NSAC.

The foregoing description of implementations provides illustration and description, but is not intended to be exhaustive or to limit the invention to the precise form disclosed. Modifications and variations are possible in light of the above teachings or may be acquired from practice of the invention. Also, while a series of blocks have been described with regard to FIGS. 5-7, the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms, such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
provisioning a network device with select network slice admission control (NSAC) criteria related to a first limit to a number of user equipment (UE) devices and a second limit to a number of protocol data unit (PDU) sessions supportable on a network slice;
receiving, by the network device, an indication that a first UE device requests a first PDU session on the network slice;
applying, by the network device, at least one of the select NSAC criteria to at least one of the first UE device or the first PDU session;
determining, by the network device and based on the applying, that at least one of the first UE device is countable toward the first limit or the first PDU session is countable toward the second limit; and
generating, by the network device, an NSAC update response message indicating that the at least one of the first UE device or the first PDU session is countable.

2. The method of claim 1, further comprising:
subscribing to a selective NSAC criteria service, for a data type, which indicates the select NSAC criteria corresponding to a network slice selection assistance information (NSSAI) identifier.

3. The method of claim 1, wherein, applying the at least one of the one or more select NSAC criteria, comprises:
comparing fewer than all of the one or more select NSAC criteria when a match is determined for a first criterion.

4. The method of claim 1, wherein, determining that at least one of the first UE device or the first PDU session is countable, comprises:
determining that results of the applying indicate that two or more of the select NSAC criteria are satisfied for the at least one of the first UE device or the first PDU session.

5. The method of claim 1, further comprising:
incrementing a current number of registered UE devices or established PDU sessions.

6. The method of claim 1, wherein the select NSAC criteria comprise at least one of:
a radio access technology (RAT)/frequency selection priority (RFSP) index;
a data network name (DNN);
a session and service continuity (SSC) mode;
an always-on PDU session type; or
location information associated with the UE device.

7. The method of claim 1, wherein the network device comprises at least one of:
a network data analytics function (NWDAF),
a network slice admission control function (NSACF),
a session management function (SMF), or
an access and mobility management function (AMF).

8. A system, comprising:
one or more network devices configured to:
manage select network slice admission control (NSAC) criteria related to a first limit to a number of user equipment (UE) devices and a second limit to a number of protocol data unit (PDU) sessions supportable on a network slice;
receive an indication that a first UE device requests a first PDU session on the network slice;
apply at least one of the select NSAC criteria to at least one of the first UE device or the first PDU session;
determine, based on the application, that at least one of the first UE device is countable toward the first limit or the first PDU session is countable toward the second limit; and
generate an NSAC update response message indicating that the at least one of the first UE device or the first PDU session is countable.

9. The system of claim 8, wherein the one or more network devices are further configured to:
subscribe to a selective NSAC criteria service, for a data type, which indicates the select NSAC criteria corresponding to a network slice selection assistance information (NSSAI) identifier.

10. The system of claim 8, wherein the one or more network devices are further configured to:
compare fewer than all of the one or more select NSAC criteria when a match is determined for a first criterion.

11. The system of claim 8, wherein, to determine that at least one of the first UE device or the first PDU session is countable, the one or more network devices are further configured to:
determine that results of the applying indicate that two or more of the select NSAC criteria are satisfied for the at least one of the first UE device or the second PDU session.

12. The system of claim 8, wherein the one or more network devices are further configured to:
increment a current number of registered UE devices or established PDU sessions.

13. The system of claim 8, wherein the select NSAC criteria comprises at least one of:
a radio access technology (RAT)/frequency selection priority (RFSP) index;
a data network name (DNN);
a session and service continuity (SSC) mode;
an always-on PDU session type; or
location information associated with the UE device.

14. The system of claim 8, wherein the one or more network devices comprise at least one of:
a network data analytics function (NWDAF),
a network slice admission control function (NSACF),
a session management function (SMF), or
an access and mobility management function (AMF).

15. A non-transitory, computer-readable storage media storing instructions, which, when executed by processors of a network device, cause the network device to:
manage select network slice admission control (NSAC) criteria related to a first limit to a number of user equipment (UE) devices and a second limit to a number of protocol data unit (PDU) sessions supportable on a network slice;
receive an indication that a first UE device requests a first PDU session on the network slice;
apply at least one of the select NSAC criteria to at least one of the first UE device or the first PDU session;
determine, based on the application, that at least one of the first UE device is countable toward the first limit or the first PDU session is countable toward the second limit; and
generate an NSAC update response message indicating that the at least one of the first UE device or the first PDU session is countable.

16. The non-transitory, computer-readable storage media of claim 15, further comprising instructions to cause the network device to:
compare fewer than all of the one or more select NSAC criteria when a match is determined for a first criterion.

17. The non-transitory, computer-readable storage media of claim 15, wherein, to determine that at least one of the first UE device or the first PDU session is countable, the instructions to cause the network device to:
determine that the results of the application indicate that two or more of the select NSAC criteria are satisfied for the at least one of the first UE device or the first PDU session.

18. The non-transitory, computer-readable storage media of claim 15, further comprising instructions to cause the network device to:
increment a current number of registered UE devices or established PDU sessions.

19. The non-transitory, computer-readable storage media of claim 15, wherein the select NSAC criteria comprises at least one of:
a radio access technology (RAT)/frequency selection priority (RFSP) index;
a data network name (DNN);
a session and service continuity (SSC) mode;
an always-on PDU session type; or
location information for the UE device.

20. The non-transitory, computer-readable storage media of claim 15, wherein the network device comprises at least one of:
a network data analytics function (NWDAF),
a network slice admission control function (NSACF),
a session management function (SMF), or
an access and mobility management function (AMF).
